(19) United States
(12) Patent Application Publication
(10) Pub. No.: US 2017/0280794 A1
(43) Pub. Date: Oct. 5, 2017

(54) PROTECTIVE MITT FOR PLAYING WITH ANIMALS

(71) Applicant: Steven C. Parrish, Rio Linda, CA (US)

(72) Inventor: Steven C. Parrish, Rio Linda, CA (US)

(21) Appl. No.: 15/470,506

(22) Filed: Mar. 27, 2017

Related U.S. Application Data
(60) Provisional application No. 62/316,776, filed on Apr. 1, 2016.

(51) Int. Cl. A41D 19/015; A01K 13/00; A01K 15/02; A41D 19/00; A41D 19/01

(52) U.S. Cl. CPC A41D 19/01505; A41D 19/002; A41D 19/0024; A41D 19/01; A01K 15/025; A01K 13/002; A41D 2300/32

(57) ABSTRACT

A mitt includes a hand cover portion and optionally also a forearm cover portion into which a hand of the user can be placed when playing with a dog, cat or other pet. A flap is coupled to the hand covering portion of the mitt at a proximal portion but dangles freely at a distal edge and provides a convenient structure for playing of tug-o-war, such as with a dog. Tassels extend from various portions of the mitt and are conveniently available for playing with a cat. A utility pouch is provided on the forearm cover which can contain various additional play accessories or other pet associated items. The mitt is formed of a leather material which is sufficiently strong to avoid cat scratches, dog bites from small dogs, and similar pet related injuries that can occur while playing with a pet.

### CROSS-REFERENCE TO RELATED APPLICATIONS

This application claims benefit under Title 35, United States Code §119(e) of U.S. Provisional Application No. 62/316,776 filed on Apr. 1, 2016.

### FIELD OF THE INVENTION

The following invention relates to toys for use in playing with animals including dogs and cats. More particularly, this invention relates to wearable hand coverings which include pet toys included therewith to simultaneously provide enjoyment for users when playing with a pet and protection from cuts, such as those associated with cat scratches and dog bites.

### BACKGROUND OF THE INVENTION

Numerous benefits are imparted by playing with dogs, cats and other similar pets. For instance, pets receive needed exercise by playing with their owners. Also, pet balance, coordination and mental state is improved through play. Play can also be integrated into training of the pet as a motivational tool. Playing with one's pet can also provide beneficial exercise to a pet owner or other handler, and provide amusement.

When playing with dogs and cats (and potentially other animals) the potential for injury is presented. With cats, typically it is the sharp claws which can result in scratches for the owner or other individual. For dogs, while the claws can be somewhat dangerous, typically it is the teeth of the dog which present the greatest threat of injury.

Typical injuries from playing with dogs and cats include scratches to the hands of the owner or other pet handler. These scratches can be painful, have the potential for introduction of infection and have the potential to exacerbate bleeding disorders, such as when an elderly individual is on blood thinners. Such risks can lead a pet owner or other pet handler to shy away from playing with the pet, and then not fully benefitting from all of the potential advantages associated with such play.

Furthermore, it is often desirable to introduce an intermediate object between the pet and hands of an individual. Such “toys” can enhance the quality of the play experience and provide an intermediate structure for the pet to “attack” rather than hands of the user. However, such toys or other implements are often misplaced or scattered about the house and must first be found and gathered before they can be effectively utilized. A pet owner or other individual also benefits from having various other pet accessories readily available while playing with the pet. Such “accessories” include pet treats for training or encouragement, and pet waste pick up bags. Such accessories can also be easily misplaced. Thus, it is beneficial to have a place for storage of such accessories in a place where they will be easy to find and use when needed.

Accordingly, a need exists for an apparatus which can protect hands of a user when playing with a dog, cat or other pet, and which also has the potential to enhance the play experience while protecting hands of the user from potential injury. Such an apparatus would also benefit from effectively storing pet toys and other accessories.

### SUMMARY OF THE INVENTION

With this invention, a mitt is provided which is worn over a hand of a user. A pair of mitts could be utilized in one embodiment, while typically only a single mitt is utilized. The mitt in a preferred embodiment is of a simple construction so that it is ambidextrous, fitting on either the left or right hand. The mitt is formed of a fabric material which is constructed with sufficient thickness and durability so that scratching or biting through the fabric of the mitt is minimized or completely avoided, goat leather (or other leather) is one suitable material.

In one embodiment, different thicknesses of fabric can be provided for selection by a user, such as thick, medium and thin fabrics or otherwise varying the material from which the mitt is formed so that a user can select the most suitable fabric. Fabrics can be optimized for use with dogs or cats as well. In one embodiment, the fabric utilizable for use with cats would have a tight and durable weave which is sufficiently tight to resist penetration by claws of the cat. The fabric can be relatively thin (e.g. thin leather) in that the cat does not apply significant pressure for creation of contusions, but rather has very sharp claws which can pass through fabric having a loose weave. In contrast, a dog play mitt according to this invention would typically have a thicker fabric so that forces associated with dog biting force or the weight behind the dog's claws can be distributed somewhat over a larger surface area so that peak forces are minimized below a force which would tend to bruise or break the skin of a wearer. An intermediate thickness leather can provide a compromise suitable for both cats and dogs, as a play instrument.

The mitt benefits from having a tug flap on a portion of the mitt which would typically overlie an outside surface of knuckles of the wearer. This tug flap in the embodiment shown is generally rectangular and is able to flap around somewhat separately from the mitt. If the user closes fingers together either within the mitt or by curling the finger portion of the mitt into a fist, the tug flap can in one embodiment be exposed away from an end thereof. The dog or cat can attack the tug flap with teeth, claws, etc. and no amount of force will cause injury to the user because the tug flap does not have the user's fingers beneath (or within) it. The tug flap can be made sufficiently durable so that aggressive play will not readily damage the tug flap.

Tassels can be suspended from the mitt, such as along an edge opposite a thumb of the mitt (or off of the thumb, or elsewhere). These tassels can be formed of reflective material or at least with a reflective coating to present a more attractive and eye catching appearance (or formed from leather or other material matching the mitt). The tassels would typically be provided for playing with cats, and so could be limited to supply with mitts which are particularly configured for use with cats. However, in other embodiments the tassels could be included on mitts designed for play with dogs, or for mitts which are designed for play with either dogs or cats (or other animals). In the embodiment, a pair of tassel bundles (also called groupings) are provided with a half dozen or so individual tassels associated with each bundle. Various different bundles of tassels and tassels of various different lengths could be provided according to this invention.

Preferably, a proximal end of the mitt or other portion of the mitt includes at least one pouch, but optionally can include a pair (or more) of exterior pouches. The pouch has an opening typically on a proximal end side of the mitt. This opening can be optionally closable with a fastener, such as hook and loop fasteners, buttons, snaps or other fasteners. The pouch can contain items which are beneficial to have handy when playing with a pet. For instance, one of the pouches can be loaded with treats, such as dog biscuits. Such treats can be beneficial when training the dog or other pet or merely as a desirable item to maintain the pet's attention. Other items which could be contained within such a pouch could include pet waste pickup bags, which would be particularly effective when the mitt is utilized out of doors.

In one embodiment, an additional elongate pouch is provided in the form of a rope slot which is within an interior of the mitt. This slot is elongate in form and allows for a tug rope to be fitted within the rope slot. Fabric sewn to the mitt interior would make up this slot. Many dogs enjoy a game of “tug-o-war” and such a rope slot can be conveniently provided within the mitt so that the rope can be stored within the mitt. In this way, the rope is always available for use when desired.

Many pets also benefit from being groomed, with some pets enjoying such a grooming process and others tolerating grooming if play (or treats or both) is employed. The front (inner panel) of the mitt can include a brush built thereinto for such a purpose. In the embodiment disclosed, a hook and loop fastener, such as that provided under the trademark VELCRO provided by Velcro Industries B.V. of the Netherlands, could be utilized with complemental halves both on a front surface of the mitt and on a rear surface of a pet grooming brush. The pet grooming brush could thus be removably attached to a front surface of the mitt. When attached to the mitt, bristles on the brush are presented on a side of the brush opposite the portion of the hook and loop fastener which interfaces with the front surface of the mitt. These bristles are thus presented for grooming of the pet.

Preferably, the mitt extends over a wrist of the user somewhat so that a wrist portion of the mitt defines a midpoint in the overall length of the mitt. The mitt thus protects the hand, wrist and forearm (at least partially). In a preferred embodiment, the mitt is approximately seventeen inches long so that it can be folded in half and have a length of a little less than nine inches. The mitt can thus be folded and fit conveniently within a package which is ten inches long for merchandizing, shipping, storage and other convenient handling.

### OBJECTS OF THE INVENTION

Accordingly, a primary object of the present invention is to provide a glove which protects a hand and forearm of a user while playing with dogs, cats and/or other pets.

Another object of the present invention is to provide a glove which includes play accessories thereon which are attractive and enjoyable for dogs, cats and other small pets, to allow the user to play with a pet using the play accessories.

Another object of the present invention is to provide a glove which includes play accessories and which protects the hand and/or forearm of the user while using the play accessories with a pet.

Another object of the present invention is to provide a method for playing with a pet which minimizes risk of injury, and especially bites and scratches from dogs, cats and other small pets.

Another object of the present invention is to provide a glove which includes a built-in tug-o-war play accessory, for enjoyment with a dog or other small pet.

Another object of the present invention is to provide a glove which includes built-in tassels for enjoyment with a cat or other small pet.

Other further objects of the present invention will become apparent from a careful reading of the included drawing figures, the claims and detailed description of the invention.

### BRIEF DESCRIPTION OF THE DRAWINGS

FIG. 1 is a perspective view of the glove of this invention in use with a dog, while playing tug-o-war with a flap of the glove.

FIG. 2 is a front perspective view of the glove of FIG. 1.

FIG. 3 is a rear perspective view of the glove of FIG. 1, and with the flap thereof shown folded back partially.

FIG. 4 is a rear perspective view of the glove of FIG. 1 and showing how a utility pouch of the glove can be opened to retrieve play accessories and other useful items stored therein.

FIG. 5 is a perspective view of the glove of FIG. 1 in use along with a cat, while playing by dangling tassels of the glove near the cat.

### DESCRIPTION OF THE PREFERRED EMBODIMENT

Referring to the drawings, wherein like reference numerals represent like parts throughout the various drawing figures, reference numeral 10 is directed to a mitt which fits over a hand (and optionally also a forearm) of a user to protect the user from scratches, bites or other injuries, while playing with a dog D, cat C, or other small pet. The mitt 10 includes play accessories thereon to simultaneously protect the user and provide enjoyable play accessories, such as a flap 40 for playing tug-o-war, or tassels 50, 60 for dangling and allowing the cat C or other pet to bat at the tassels 50, 60.

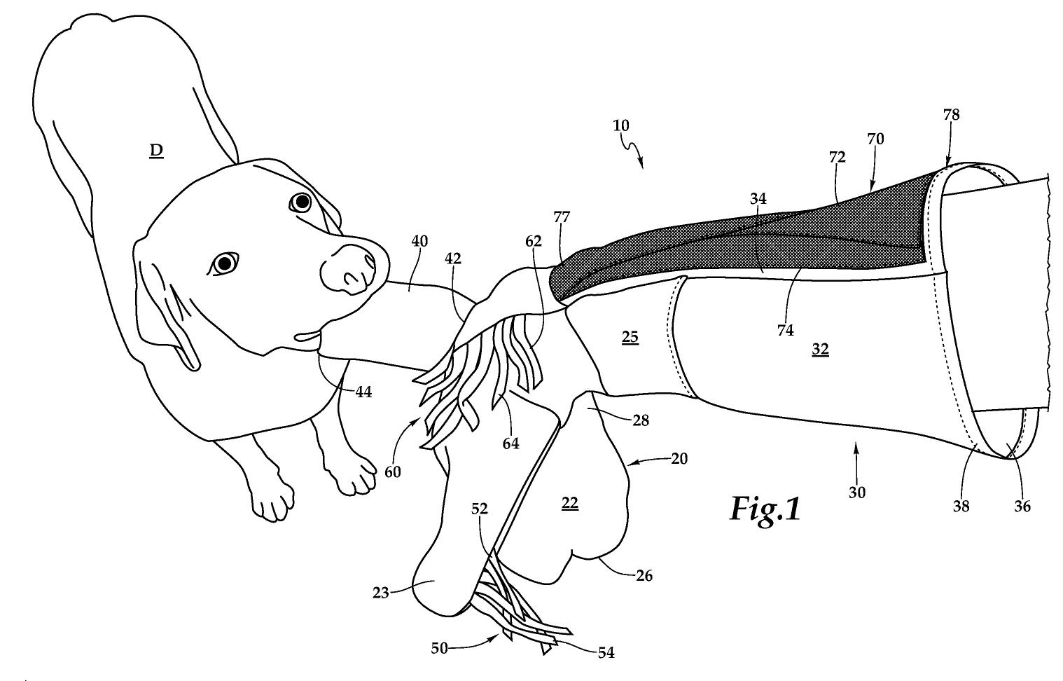

In essence, and with particular reference to FIG. 1, basic details of the mitt 10 are described, according to a preferred embodiment. The mitt 10 includes a hand cover 20 and a forearm cover 30 which encapsulate the hand and forearm of a user. A collar 36 of the forearm cover 30 defines an opening into which a hand of a user can be inserted and removed for donning and doffing of the mitt 10. A flap 40 is attached to the mitt 10, preferably located on a rear side of the hand cover 20. The flap 40 can be presented to a dog D (FIG. 1) or other small pet for playing of tug-o-war, without concern teeth of the dog D will injure the user.

Thumb tassels 50 extend from a thumb sleeve 23 of the hand cover 20. Wrist tassels 60 extend from a wrist sleeve 25 portion of the mitt 10 between the hand cover 20 and the forearm cover 30. The tassels 50, 60 can be presented to a cat C or other small pet without concern that sharp claws S of the cat C will scratch the user. A utility pouch 70 is located on the forearm cover 30 which is selectively openable and closable to allow for further play accessories or other pet related items (or non-pet related items) to be contained therein. Typical items to be stored can include pet waste bags, pet treats (such as for training purposes) and auxiliary toy play accessories, such as tug-o-war rope, string, and other enjoyable pet play accessories.

With particular reference to FIGS. 1-3, details of the hand cover 20 of the mitt 10 are described, according to this preferred embodiment. The hand cover 20 includes an inner panel 22 joined to an outer panel 24 at a perimeter thereof. These panels 22, 24 thus form the hand cover 20 extending from a closed tip 26 at the most distal portion thereof to an open root 28 at a more proximal portion thereof. While these panels 22, 24 could be separate and sewn together, they could alternatively be a single flexible structure sewn or otherwise formed to take on a hand encapsulating form. More than two panels 22, 24 could also provide the hand cover 20, as an alternative.

A side of the hand cover 20 between the inner panel 22 and outer panel 24 includes a thumb sleeve 23 extending therefrom. This thumb sleeve 23 can be formed from one or more panels sewn (or otherwise formed) together and provides a space for a thumb of a user's hand while the user's hand is within the hand cover 20 between the panels 22, 24.

The root 28 of the hand cover 20 transitions into the wrist sleeve 25 which is positioned to cover a wrist of a user wearing the mitt 10. The wrist sleeve 25 is generally cylindrical and hollow and formed from one or more separate panels, preferably of a common material with the hand cover 20. Preferably, an elastic band 27 is sewn into the wrist sleeve 25 or otherwise attached to the wrist sleeve 25 so that the wrist sleeve 25 is elastically contracted somewhat and tends to hold to a wrist of a user while a hand of the user is inside of the hand cover 20. With the hand cover 20 configured as described above, it is generally in the form of a mitten. As an alternative, the hand cover 20 could be configured to include separate finger sleeves so that the hand cover 20 would be configured more as a glove, rather than as a mitten.

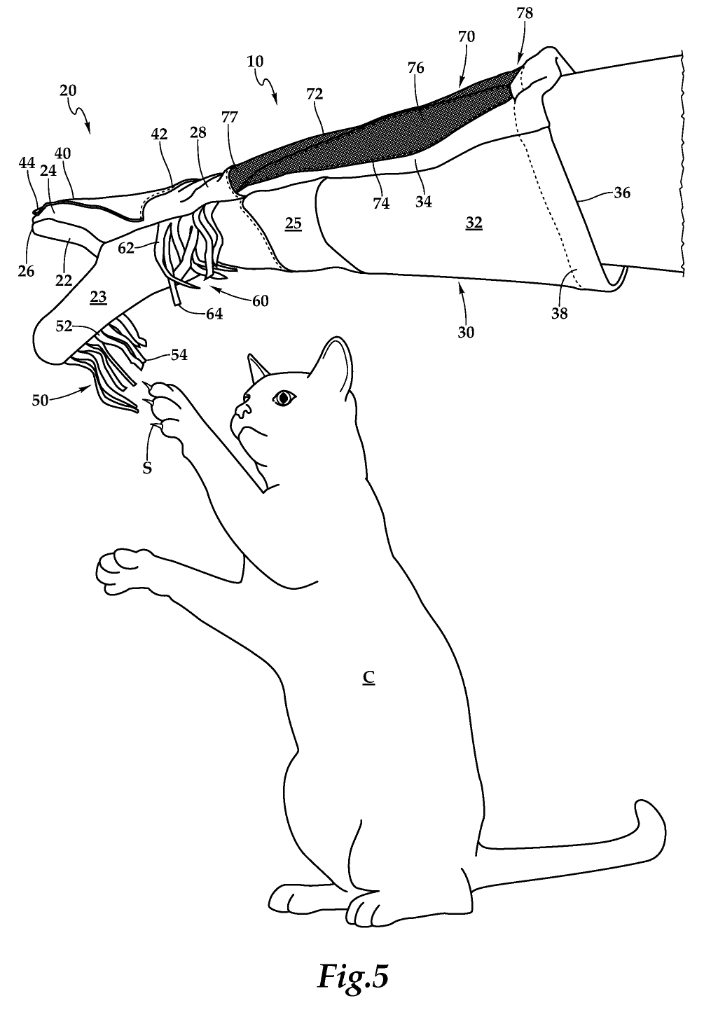

The hand cover 20 is preferably formed of a soft relatively thin leather. Leather is both comfortable for the user and also resistant to penetration by teeth or claws, such as teeth of a dog D (FIG. 1) or sharp claws S of a cat C (FIG. 5). The leather preferably has a thickness of approximately 1/16 inch. One suitable leather that has been shown to work effectively is goat leather. While leather is preferred, other materials could be used as an alternative, provided it does not make the individual too prone to bruising and/or skin tears and bleeding. Some individuals might enjoy a thicker material to provide an even greater level of protection. Conversely, some people with tough skin might prefer lighter material and still consider themselves to be sufficiently protected.

With continuing reference to FIGS. 1-3, details of the forearm cover 30 are described, according to this preferred embodiment. The forearm cover 30 preferably is formed of a similar material as that forming the hand cover 20. The forearm cover 30 preferably extends from the wrist sleeve 25 of the hand cover 20 to provide protection for at least a portion of the forearm of a user. The forearm cover 30 includes an inside panel 32 opposite an outside panel 34, with these two (or more (or just one)) panels 32, 34 sewn or otherwise joined at lateral edges to each other. These panels 32, 34 generally extend from the inner panel 22 and outer panel 24 of the hand cover 20. As one alternative, the panels 32, 34 of the forearm cover 30 could be provided as a longer alternative of the panels 22, 24 of the hand cover 20, so that the hand cover 20 and forearm cover 30 would be integrated together. The most proximal portion of the forearm cover 30 terminates at a collar 36 which preferably includes a hem 38 thereon which provides a clean finish for this proximal portion of the forearm cover 30 and which surrounds an opening into which a hand and forearm of a user can be passed for insertion into and removal from the mitt 10.

With particular reference to FIGS. 1 and 3, details of the flap 40 are described, according to this preferred embodiment. The flap 40 provides one form of play accessory which is particularly useful in playing tug-o-war, such as with a dog D (FIG. 1). The flap 40 includes a proximal edge 42 opposite a distal edge 44. The proximal edge 42 is connected to the hand cover 20, such as at the root 28 of the hand cover 20, where the hand cover 20 transitions from the outer panel 24 to wrist sleeve 25. The flap 40 can have a size similar to that of the outer panel 24 so that it lays on the backside of a hand of the user while the user is wearing the mitt 10. The distal edge 44 of the flap 40 can be dangled in front of a dog D, and the dog is then encouraged to bite onto the flap 40. Many dogs D enjoy playing tug-o-war with an individual wearing the mitt 10 who can then easily play tug-o-war by letting the dog D grip the flap 40 between the dog's teeth and pull. While the flap 40 is shown adjacent to the outer panel 24 of the hand cover 20, the flap 40 could extend in some other fashion from the hand cover 20 or forearm cover 30 of the mitt 10.

With particular reference to FIGS. 2, 3 and 5, details of the tassels 50, 60 are described, according to this preferred embodiment. The tassels 50, 60 are preferably provided in separate groupings. One of these groupings is a bundle of thumb tassels 50 and the other is a bundle of wrist tassels 60. These tassels 50, 60 extend between about one inch and three inches and dangle in a fashion which is exceptionally attractive, especially to cats C (FIG. 5). The thumb tassels 50 extend from attached ends 52 where they are joined to the thumb sleeve 23, out to free ends 54, so that the tassels 50 dangle from the thumb sleeve 23 of the hand cover 20. The wrist tassels 60 extend from attached ends 52 joined to the wrist sleeve 25 of the hand cover 20, out to free ends 64 opposite the attached end 62. The wrist tassels 60 similarly dangle from the mitt 10 and provide an attractive toy for a cat C or other small pet to attack and play with.

Beneficially, the tassels 50, 60 are readily available while the user is wearing the mitt 10. Thus, a user does not need to find tassels to play with, or risk dangling of tassels, string or similar devices adjacent to a cat C without protection, which can lead to a painful scratch from sharp claws S (and potentially also teeth) of a cat C or other small pet. It can be difficult to grasp small items such as string when wearing a mitten or glove. With this invention, the user does not need to grasp the tassels 50, 60. Rather, the tassels 50, 60 are attached to the mitt 10 so that they are already properly attached and available for play with a cat C or other small pet.

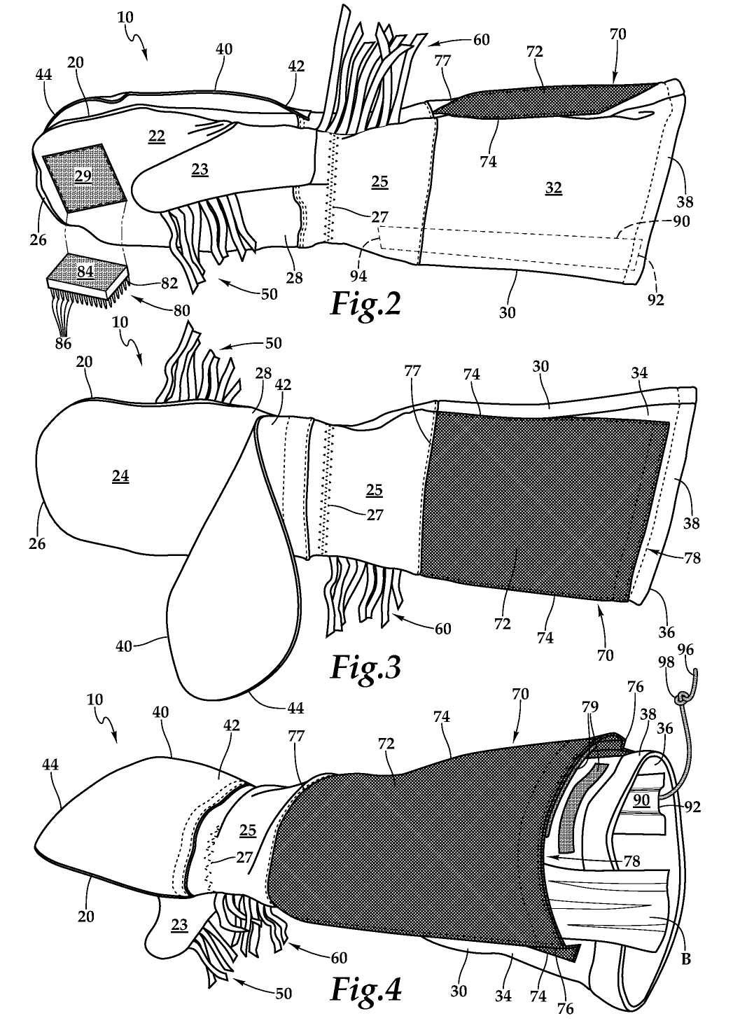

With particular reference to FIG. 4, details the utility pouch 70 are described, according to a preferred embodiment. The utility pouch 70 is formed by an outer wall 72 which has lateral edges 74 and a closed end 77 thereof which are sewn to or otherwise permanently attached to the outside panel 34 of the forearm cover 30. Preferably, the lateral edges 74 are provided with pleats 76 to enhance a volume of the utility pouch 70 between the outer wall 72 and the outside panel 30 for the forearm cover 30.

An opening 78 is provided opposite the closed end 77. Hook and loop fasteners 79 are preferably provided adjacent to the opening 78 to allow for alternative opening and closing of the opening 78. The hook and loop fasteners 79 have two separate parts which are complementary to each other, including a hook part and a loop part, with one of these parts attached to the outer wall 72 adjacent to the opening 78 and with the other part of the fastener 79 provided on the outside panel 34 of the forearm cover 30, and appropriately located so that the two parts of the fastener 79 can be brought adjacent to each other to close the opening 78, or separated from each other to allow for access through the opening 78. Other forms of fasteners could alternatively be used for selective closing of the opening 78, such as snaps, zippers, buttons or other fasteners.

The utility pouch 70 is shown containing pet waste bags B therein. Other items which can be usefully carried within the utility pouch 70 can include items such as a dog leash, pet treats (such as for training), a whistle (such as for training) and additional toys such a string, a length of rope, a feather, or other toys which might be enjoyed by a dog D or a cat C. Preferably, the utility pouch 70 is formed of some material other than leather, since the outer wall 72 of utility pouch 70 is not required for protection. As an alternative, the outer wall 72 could be formed of leather or other common material from which the hand cover 20 and forearm cover 30 are formed.

In the most preferred form of this invention at least two additional components are included with the mitt 10 of this invention, including a grooming brush 80 and an elongate pouch 90. One or more of these additional components could be provided in addition to that which is disclosed above as optional enhancements to the mitt 10 according to various embodiments of this invention. The grooming brush 80, if provided, is preferably removable from and reattachable to the hand cover 20 of the mitt 10.

In particular, and with reference to FIG. 2, the inner panel 22 of the hand cover 20 can include an attachment surface 29 thereon. Similarly, the grooming brush 80 can include an attachment surface 84 on one surface thereof opposite a grooming surface 82. Attachment surfaces 29, 84 are preferably configured as complementary halves of a hook and loop fastener system. One such hook and loop fastener system is that provided under the trademark VELCRO, disclosed above.

Most preferably, the hook portion of the hook and loop fastener provides the attachment surface 29 on the inner panel 22 of the hand cover 20. The loop portion of the hook and loop fastener system would then be provided on the attachment surface 84 of the brush 80. In such a configuration, the hooks on the attachment surface 29 can serve two purposes. First, they can attach to the loops on the attachment surface 84, to allow for removable attachment of the grooming surface 82 of the brush 80 to the hand cover 20. When the grooming brush 80 is so attached, the mitt 10 can be used for grooming of a dog, cat or other pet, without the user needing to actively grasp the grooming brush 80, as it is attached directly to the hand cover 20. Second, if the grooming brush 80 is not attached, the hooks on the attachment surface 29 can double as a form of grooming fabric which can be desirable for the pet and also loosen and remove loose fur from the pet.

The grooming surface 82 of the grooming brush 80 preferably include grooming elements 86 thereon which are one of a variety of grooming elements 86 which are known in the prior art for removal of loose fur from a pet. In the example shown, cones of appropriate rubber type material are utilized which exhibit a static attraction to pet hair, and are somewhat resilient. In another embodiment, stiff brush-like fibers could be provided, or one-way fabric could be provided which grasps and removes loose pet hair when moving in the first direction, but not in the second direction (are being omni-directional). Other forms of pet grooming elements could alternatively be provided on the grooming surface 82 if desired. A user could thus choose to either have the grooming brush 80 on the hand cover 20, or to remove the grooming brush 80 and have a hand cover 20 available without the grooming brush 80 thereon. As a further alternative, a user can use the grooming brush 80 with a second hand of the user, while a first hand of the user is inside of the mitt 10.

With reference to FIGS. 2 and 4, details of an elongate pouch 90 are described, as a further option to be included with the mitt 10 according to an alternative embodiment of this invention. The elongate pouch 90 is preferably located within an interior of the mitt 10 with an entry end 92 adjacent to the opening of the forearm cover 30 into which a hand and forearm of a user can be passed for insertion into and removal from the mitt 10. This entry end 92 is located opposite a typically closed end 94.

The elongate pouch 90 preferably is provided by having a substantially rectangular elongate piece of flexible fabric sewn at elongate lateral edges thereof within an interior of the forearm cover 30, and with the fabric having a greater width than a spacing between these two seams, so that the elongate pouch 90 tends to remain loosely open, and with at least the entry end 92 open for access thereinto.

The end of the elongate pouch 90 opposite the entry end 92 is preferably closed and defines a closed end 94. A rope 96 or other elongate pet toy (such as a wand with a feather (reflective tinsel or other attractant) on an end thereof, or other elongate toy) can be placed into the elongate pouch 90 and stored therein when not in use. When a rope 96 is stored within the the elongate pouch 90, preferably a knot 98 is formed in the rope 96.

Animals like to play tug-o-war with a rope, such as the rope 96, and a knot 98 can further enhance such play with a pet, providing an area to be more firmly grasped either by the user or by the pet. The knot 98 can also tend to help to keep the rope 96 firmly contained within the elongate pouch 90, by stuffing the knot 98 partially into the entry end 92 of the elongate pouch 90. If desired, some form of closure can be provided over the entry end 92 which can removably close the elongate patch 90. It is not strictly necessary that the closed end 94 be closed, but rather the closed end 94 could terminate and remain open. In this way, an elongate rope 96 can extend past the closed end and extend deeper into the mitt 10, such that a longer rope 96 can be contained than what would fit entirely within the elongate pouch 90.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1. A protective mitt with pet play features, comprising in combination:
a hand covering portion including an inner panel and an outer panel to produce a compartment surrounded by said inner panel and said outer panel and closed at a tip thereof, said compartment large enough for a human hand to fit into said compartment;
said hand covering portion including a thumb sleeve partially isolated from said compartment and positioned and sized to cover a thumb of a human hand while other portions of the hand fit in said compartment; and
a tug-o-war play flap having a proximal edge opposite a distal edge, said proximal edge coupled to said hand covering portion and said distill edge not coupled to said hand covering portion other than through said proximal edge.

2. The protective mitt of claim 1 wherein a wrist sleeve extends proximally away from said hand covering portion to cause said compartment to be sufficiently long to substantially contain both a human hand and human wrist therein, said wrist sleeve circumscribing said compartment.

3. The protective mitt of claim 2 wherein elastic is included within said wrist sleeve, said elastic causing said wrist sleeve to have a smaller diameter than it would otherwise have without said elastic.

4. The protective mitt of claim 3 wherein said proximal edge of said tug-o-war flap is attached to a junction between said hand covering portion and said wrist sleeve.

5. The protective mitt of claim 4 wherein said hand covering portion is formed a majority from leather material.

6. The protective mitt of claim 5 wherein said tug-o-war flap is formed of leather, and particularly goat leather.

7. The protective mitt of claim 6 wherein play tassels are provided in at least two groupings of multiple tassels, a first tassel grouping extending from said wrist sleeve and a second tassel grouping extending from said thumb sleeve.

8. The protective mitt of claim 7 wherein a forearm cover extends proximally from said wrist sleeve, said forearm cover extending a length of said compartment to cover portions of a human forearm while portions of the human hand are located within said hand covering portion.

9. The protective mitt of claim 8 wherein a pouch is located on an outer portion of said forearm cover, said pouch having an interior spaced from said compartment.

10. The protective mitt of claim 9 wherein said pouch includes an outer wall joined to said forearm cover at lateral edges thereof other then at an opening on a proximal side of said outer wall, said lateral edges of said pouch joined to said forearm cover through pleats, such that a volume of said pouch is increased over what it would be without said pleats.

11. The protective mitt of claim 10 wherein said pouch includes a closure at said opening, said closure including complemental hook and loop fastener material attached to said outer wall of said pouch adjacent to said opening and attached to said forearm cover adjacent to said opening, so that said complemental hook and loop fastener can have separate parts thereof removably coupled together for selective closing of said interior of said pouch.

12. A method for protecting an individual from cuts while playing with a pet, the method including the steps of:
placing a hand into a compartment of a mitt, the mitt having a hand covering portion including an inner panel and an outer panel to produce a compartment surrounded by the inner panel and the outer panel and closed at a tip thereof, the compartment large enough for a human hand to fit into the compartment, the hand covering portion including a thumb sleeve partially isolated from the compartment and covering a thumb of a human hand while other portions of the hand fit in that compartment, and with at least one play accessory attached to the mitt; and
presenting the play accessory to a pet for play between the user of the mitt and the pet, while the hand of the user stays inside of the mitt.

13. The method of claim 12 wherein said presenting step includes the mitt having a tug-o-war flap with a proximal edge opposite a distal edge, said proximal edge coupled to the hand covering portion and the distal edge not coupled to the hand covering portion other than through the proximal edge; and
said presenting step includes presenting the flap to the pet so that the pet grabs a hold of the flap and the user plays tug-o-war with the pet.

14. The method of claim 12 wherein said placing step includes the mitt having tassels extending therefrom; and
wherein said presenting step includes dangling the tassels adjacent to a pet until the pet attacks the tassels, and with the mitt protecting the user from scratches and/or bites.

15. The method of claim 14 wherein said presenting step includes the mitt having at least two sets of tassels including some tassels dangling from the thumb sleeve of the hand covering portion and some tassels extending from a wrist sleeve extending proximally from the hand covering portion.

16. The method of claim 12 including the further step of storing a play accessory within a pouch coupled to said hand covering portion; and
removing the play accessory from the pouch to play with the pet.

17. The method of claim 16 wherein said placing step includes a forearm cover extending proximally from the hand covering portion and enlarging the compartment to surround portions of a forearm of a user.

18. The method of claim 17 wherein said pouch includes an outer wall joined to said forearm cover at lateral edges thereof and at a closed end thereof, but with the outer wall left free from attachment to the forearm cover at an opening into an interior of the pouch at a proximal end thereof.

19. The method of claim 18 wherein said placing step includes the pouch having pleats at lateral edges of the outer wall, such that a volume of the interior of the pouch is greater than it would be without the pleats.

20. The method of claim 19 wherein the pouch includes a closure at the opening, the closure including complemental hook and loop fastener material attached to said outer wall of the pouch adjacent to the opening and attached to the forearm cover adjacent to the opening, so that the complemental hook and loop fastener can have separate parts thereof removably coupled together for selective closing of the interior of the pouch.
